(19) United States
(12) Patent Application Publication
(10) Pub. No.: US 2023/0402924 A1
(43) Pub. Date: Dec. 14, 2023

(54) CONTROL DEVICE AND POWER STORAGE SYSTEM

(71) Applicant: Mitsubishi Electric Corporation, Tokyo (JP)

(72) Inventors: Keisuke OGASAWARA, Tokyo (JP); Akiko TABUCHI, Tokyo (JP); Seiji HIRAI, Tokyo (JP)

(73) Assignee: Mitsubishi Electric Corporation, Tokyo (JP)

(21) Appl. No.: 18/035,302

(22) PCT Filed: Feb. 5, 2021
(86) PCT No.: PCT/JP2021/004211

§ 371 Date: May 4, 2023

(51) Int. Cl. H02M 3/158; H02M 1/14; H02M 1/00

(52) U.S. Cl. CPC H02M 3/1582; H02M 1/143; H02M 1/0009

(57) ABSTRACT

Provided is a control device for suppressing performance reduction of a power storage device. The control device includes: a detector to detect a power storage device parameter relevant to a power storage device; an impedance calculator to calculate an impedance of the power storage device from output of the detector; and a ripple current calculator to calculate an amplitude of ripple current applied to the power storage device, from output of the detector. A converter is controlled on the basis of output of the impedance calculator and output of the ripple current calculator.

### TECHNICAL FIELD

The present disclosure relates to a control device and a power storage system.

### BACKGROUND ART

When a power storage device formed from a lithium-ion battery, a fuel cell, or a lead storage battery is used outside a predetermined voltage range or a predetermined current range, the performance of the power storage device might be significantly reduced or the power storage device might be deteriorated. Therefore, voltage and current of the power storage device are controlled. As a control technology for the power storage device, for example, it has been proposed that, when the temperature of the power storage device is low, a current reference for superimposing an AC current waveform on DC output current of a charging device is generated, and a semiconductor switching element of an inverter unit included in a DC/DC converter unit is driven on the basis of the current reference, thereby superimposing AC current on the DC output current, thus increasing the temperature of the power storage device (see, for example, Patent Document 1).

### CITATION LIST

### Patent Document

Patent Document 1: Japanese Laid-Open Patent Publication No. 2013-030351

### SUMMARY OF THE INVENTION

### Problems to be Solved by the Invention

There is a case where, in a converter connected to a power storage device, ripple current occurs during switching of a semiconductor switching element and the ripple current is applied to the power storage device. The impedance of the power storage device changes depending on states such as temperature, voltage, state of charge (SOC), current, and ripple frequency. Therefore, depending on the state of the power storage device, large ripple current is applied to the power storage device. When large ripple current is applied to the power storage device, the power storage device might be used outside a predetermined voltage/current range, thus causing a problem that the performance is reduced.

The present disclosure has been made to solve the above problem, and an object of the present disclosure is to provide a control device and a power storage system that suppress reduction in the performance of a power storage device.

### Solution to the Problems

A control device according to the present disclosure is a control device for controlling a converter which converts at least one of voltage inputted to a power storage device and voltage outputted from the power storage device, by a semiconductor switching element, the control device including: a detection unit which detects a power storage device parameter relevant to the power storage device; an impedance calculation unit which calculates an impedance of the power storage device from output of the detection unit; and a ripple current calculation unit which calculates an amplitude of ripple current applied to the power storage device, from output of the detection unit. The converter is controlled on the basis of output of the impedance calculation unit and output of the ripple current calculation unit.

### Effect of the Invention

The control device according to the present disclosure includes: the detection unit which detects the power storage device parameter relevant to the power storage device; the impedance calculation unit which calculates the impedance of the power storage device from output of the detection unit; and the ripple current calculation unit which calculates the amplitude of the ripple current applied to the power storage device, from output of the detection unit. The converter is controlled on the basis of output of the impedance calculation unit and output of the ripple current calculation unit. Thus, performance reduction of the power storage device can be suppressed.

### BRIEF DESCRIPTION OF THE DRAWINGS

FIG. 1 is a block diagram showing the configuration of a control device according to embodiment 1.

FIG. 2 shows the relationship between the temperature and the resistance of a battery.

FIG. 3 shows the relationship between the SOC and the resistance of a battery.

FIG. 4 shows voltage variation when DC voltage and ripple current are applied to a battery.

FIG. 5 shows the relationship between the current value of DC current inputted/outputted to/from a battery and the resistance thereof.

FIG. 6 shows the relationship between the current value of DC current inputted/outputted to/from a fuel cell and the resistance thereof.

FIG. 7 shows the relationship between the current value of DC current inputted/outputted to/from the fuel cell and the voltage value thereof.

FIG. 8 is an impedance Bode plot showing the relationship between a frequency and the resistance of a lithium-ion battery.

FIG. 9 shows an equivalent circuit of a converter in embodiment 1.

FIG. 10 shows an equivalent circuit of a power storage device in embodiment 1.

FIG. 11 is an impedance Nyquist diagram of one cell of a battery.

FIG. 12 shows the relationship between a deterioration speed and the difference between voltage variation and upper limit voltage at each temperature in the power storage device.

FIG. 13 is a block diagram showing the configuration of a control device according to embodiment 2.

FIG. 14 shows an example of an equivalent circuit of a converter in embodiment 2.

FIG. 15 shows ripple currents combined in a converter in a comparative example.

FIG. 16 shows ripple currents combined in the converter of embodiment 2.

FIG. 17 shows the relationship between converter loss and DC current of the converter in embodiment 2.

FIG. 18 shows the relationship between battery loss and ripple current applied to the power storage device in embodiment 2.

FIG. 19 is a schematic diagram showing an example of hardware of the control device according to each of embodiments 1 and 2.

### DESCRIPTION OF EMBODIMENTS

Hereinafter, a control device according to embodiments of the present disclosure will be described in detail with reference to the drawings. In the drawings, the same reference characters denote the same or corresponding parts.

### Embodiment 1

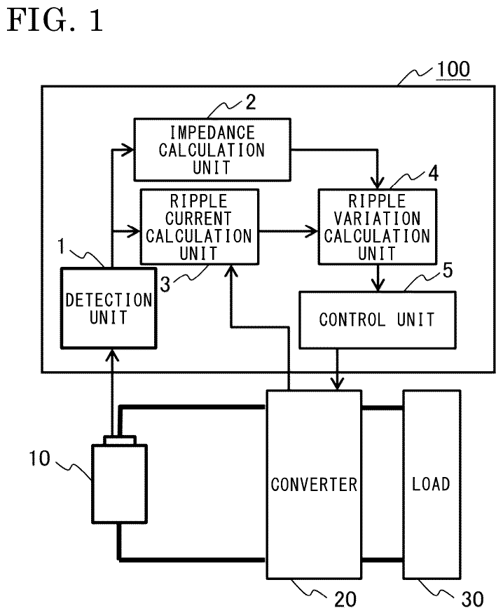

FIG. 1 is a block diagram showing the configuration of a control device 100 according to embodiment 1. A power storage device 10 is composed of one or a plurality of batteries. A converter 20 converts voltage outputted from the power storage device 10, so as to boost or step down the voltage, and supplies power to a load 30, or converts voltage to be inputted to the power storage device 10, so as to boost or step down the voltage. The control device 100 includes a detection unit 1, an impedance calculation unit 2, a ripple current calculation unit 3, a ripple variation calculation unit 4, and a control unit 5. The detection unit 1 is a detector for detecting at least one of the temperature of the power storage device 10, the voltage value thereof, the state of charge (SOC) thereof, the current value of DC current inputted to the power storage device 10, the current value of DC current outputted from the power storage device 10, and the frequency of ripple current applied to the power storage device 10, which are power storage device parameters relevant to the power storage device 10. The impedance calculation unit 2 calculates the impedance of the power storage device 10 from output of the detection unit 1. The ripple current calculation unit 3 calculates the magnitude of ripple current applied to the power storage device 10 from output of the detection unit 1. The ripple variation calculation unit 4 estimates voltage variation of the power storage device 10 on the basis of the values of the impedance of the power storage device 10 and the ripple current. The control unit 5 controls the converter 20 so that the value of voltage variation which is output of the ripple variation calculation unit 4 does not go outside a prescribed voltage range of the power storage device 10 set in advance.

A configuration including the control device 100, the power storage device 10, and the converter 20 corresponds to a power storage system.

The kind of the battery composing the power storage device 10 is not limited to a lithium-ion secondary battery, and may be a fuel cell, a lead storage battery, a nickel-hydrogen battery, or the like. The shape of the power storage device 10 may be a layer-built type, a wound type, a button type, or the like, and the configuration described in embodiment 1 is applicable to power storage devices having various shapes. The power storage device 10 is not limited to a single battery, and may be a module or a pack in which a plurality of batteries are connected in series or parallel. The converter 20 may be a unidirectional converter, a converter having a bidirectional function, a DC/DC converter, an inverter which converts DC power from the power storage device 10 to AC power for the load 30, or the like.

For the power storage device 10, an upper limit voltage and a lower limit voltage of a prescribed voltage range, and an upper limit current as a prescribed current range, are set, and if the power storage device 10 is used outside the set prescribed voltage range or prescribed current range, there is a possibility that performance reduction or deterioration occurs. In a case where a lithium-ion secondary battery is used above the upper limit voltage, the lithium-ion secondary battery is overcharged, Li metal is deposited on a negative electrode, and an internal electrolytic solution forms a coating film through side reaction, so that the resistance increases, and in addition, gas is generated through decomposition reaction of the electrolytic solution and the container expands, so that the contact state between electrodes might become poor. Further, as deposition of Li on the negative electrode progresses, internal short-circuit between the positive and negative electrodes might be caused by the deposited Li metal, or malfunction might occur due to heat generation reaction when overcharging occurs due to deposition of Li.

In a case where the lithium-ion battery is used below the lower limit voltage, structural breakage due to Li entering the positive electrode, dissolution of copper of a negative electrode current collector, or deposition thereof occurs, and if the lithium-ion battery is charged after that, slight short-circuit or the like occurs, so that performance reduction or deterioration might occur. In a case where current flows above the upper limit current in the lithium-ion battery, the battery temperature increases through Joule heat generation based on a product of current and the internal resistance of the battery, and further, if the lithium-ion battery is charged with current above the upper limit current, Li metal is deposited on the negative electrode, so that performance reduction or deterioration might occur.

In a case where the lead battery is used above the upper limit voltage, current collectors are corroded, or water of an electrolytic solution undergoes electrolysis, so that conductivity is reduced due to the liquid shortage. If the lead battery is used below the lower limit voltage, for example, lead sulfate generated at the negative electrode is deposited as sulfation, so that performance reduction or deterioration might occur. In a case of the fuel cell, voltage is determined by the flowing current value, and therefore, if the flowing current is excessively large, supply of hydrogen gas and air does not keep up and voltage is reduced, so that performance reduction or deterioration might occur.

Therefore, batteries are generally designed so as to be protected through measurement of voltage, current, temperature, and the like. However, in a converter that converts voltage of a battery, ripple current occurs due to switching of a semiconductor switching element such as IGBT or MOSFET used as a switching device. If the caused ripple current is applied to the battery, voltage of the battery varies, so that the voltage might increase above the upper limit voltage or decrease below the lower limit voltage. Ripple that occurs during switching of the semiconductor switching element may be ripple voltage, and in this case, current flowing through the battery varies. In order that the ripple current is not applied to the battery, measures in terms of designing are taken by increasing the capacitance of a smoothing capacitor in the converter or arranging and designing an appropriate reactor, or measures in terms of control are taken by controlling a switching frequency of the semiconductor switching element in the converter, e.g., increasing the switching frequency so as to reduce ripple current, or performing operation in a reactor-multiplexed state using a converter having multiplexed reactors.

In a case of converting voltage in the converter 20 shown in FIG. 1, a semiconductor switching element inside the converter 20 is caused to perform switching operation. The switching operation may be performed in accordance with a pulse width modulation (PWM) signal based on pulse width modulation. For generation of the PWM signal, for example, a triangular wave is used and the carrier frequency is set.

In the control device 100 in embodiment 1 shown in FIG. 1, the detection unit 1 detects at least one of the temperature of the power storage device 10, the voltage value thereof, the SOC thereof, the current value of DC current inputted/outputted to/from the power storage device 10, and the frequency of ripple current applied to the power storage device 10, which are power storage device parameters relevant to the power storage device 10, and the impedance calculation unit 2 calculates the impedance of the power storage device 10 on the basis of the value detected by the detection unit 1. Since impedance change in the battery is mainly influenced by the temperature, the detection unit 1 may detect at least the temperature of the power storage device 10.

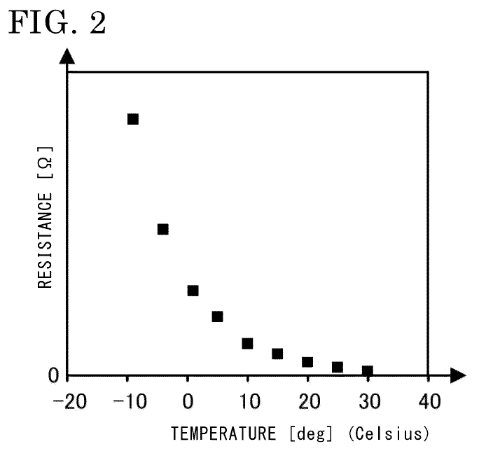

With reference to FIG. 2 to FIG. 8, change in the impedance of a battery will be described, and a method for calculating the impedance by the impedance calculation unit 2 from the value detected by the detection unit 1 will be described. FIG. 2 shows the relationship between the temperature and the resistance of a battery. In the battery, as the temperature becomes lower, the resistance increases, and as the temperature becomes higher, the resistance decreases. Therefore, when the temperature of the battery is low, the impedance becomes great, and if ripple current is applied to the battery, variation in voltage also becomes great. For example, even if the upper limit voltage and the lower limit voltage of the battery are not exceeded when ripple current is applied to the battery under an ordinary temperature from 15 degrees Celsius to 25 degrees Celsius, variation in voltage may become great when ripple current is applied under a low temperature, so that the upper limit voltage or the lower limit voltage is exceeded, leading to performance reduction or deterioration. For example, in a case where the lithium-ion battery is used above the upper limit voltage under, in particular, a low temperature, there is a high possibility that Li metal is deposited on the negative electrode and thus performance reduction or deterioration occurs. In a case where the detection unit 1 detects the temperature of the power storage device 10, the impedance calculation unit 2 stores in advance information indicating the relationship between the temperature and the resistance of the power storage device 10 as shown in FIG. 2, and converts the value of the temperature detected by the detection unit 1 to a resistance value corresponding to the impedance of the power storage device 10, using the information indicating the relationship between the temperature and the resistance as shown in FIG. 2. In the impedance calculation unit 2, the information as shown in FIG. 2 may be stored as a map, a table, an expression, or a function.

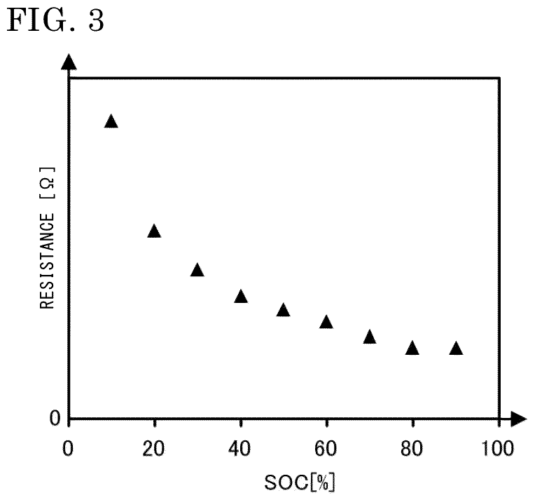

FIG. 3 shows the relationship between the SOC and the resistance of a battery. In general, as the SOC or the voltage of the battery becomes lower, the resistance value increases. Therefore, if current ripple is applied to the battery when the SOC of the battery is low, variation in voltage of the battery becomes great, so that the battery might be used in a range below the lower limit voltage of the battery. On the other hand, if ripple current is applied to the battery when the SOC of the battery is high, voltage of the battery varies, so that the battery might be used above the upper limit voltage of the battery, leading to performance reduction or deterioration. In a case where the detection unit 1 detects the SOC, the impedance calculation unit 2 stores in advance information indicating the relationship between the SOC and the resistance of the power storage device 10 as shown in FIG. 3, and converts the value of the SOC detected by the detection unit 1 to a resistance value corresponding to the impedance of the power storage device 10, using the information indicating the relationship between the SOC and the resistance as shown in FIG. 3. In the impedance calculation unit 2, the information as shown in FIG. 3 may be stored as a map, a table, an expression, or a function.

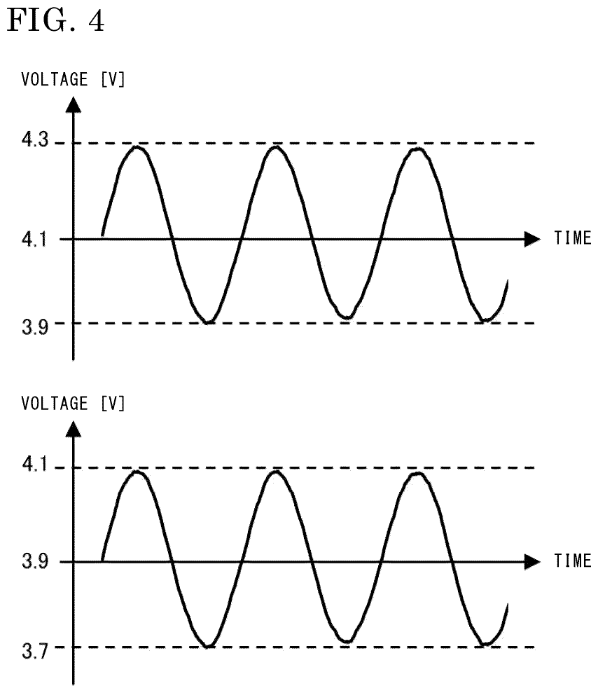

A graph on the lower side in FIG. 4 shows voltage variation when DC voltage of 3.9 V and ripple current are applied to the battery, and a graph on the upper side in FIG. 4 shows voltage variation when DC voltage of 4.1 V and ripple current are applied to the battery. In the graphs on the lower and upper sides in FIG. 4, ripple currents having the same amplitude are applied. For example, in a case where the upper limit voltage of the prescribed voltage range of the battery is 4.2 V, as shown in the graph on the upper side in FIG. 4, when DC voltage of 4.1 V and ripple current are applied to the battery, the voltage exceeds the upper limit voltage, so that deterioration occurs. However, as shown in the graph on the lower side in FIG. 4, when DC voltage of 3.9 V and ripple current are applied to the battery, the voltage does not exceed the upper limit voltage, so that deterioration does not occur.

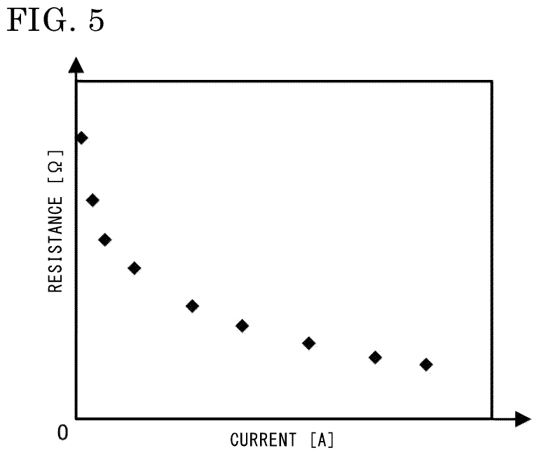

FIG. 5 shows the relationship between the current value of DC current inputted/outputted to/from a battery and the resistance thereof. For example, in a lead storage battery, as shown in FIG. 5, the battery resistance changes depending on the magnitude of the current value of inputted/outputted DC current. This feature is mainly based on the influence of ion diffusion or concentration diffusion occurring inside the battery through charging or discharging. Since the resistance increases as the current value of DC current inputted/outputted to/from the battery or the average value of the current decreases, there is a possibility that voltage variation becomes great when ripple current is applied, so that the upper limit voltage or the lower limit voltage of the prescribed voltage range of the battery might be exceeded.

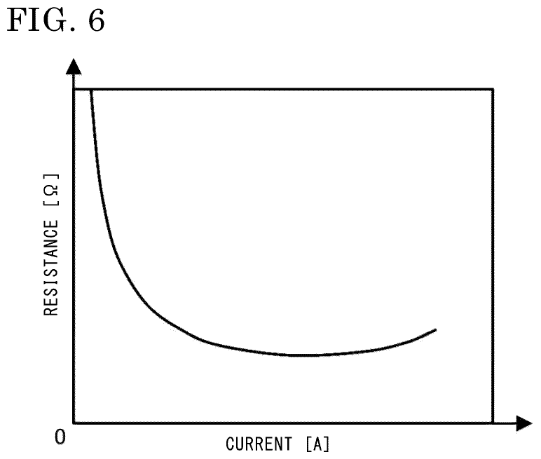

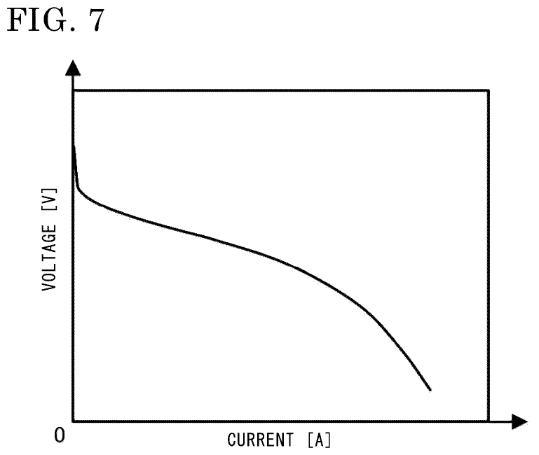

FIG. 6 shows the relationship between the current value of DC current inputted/outputted to/from a fuel cell and the resistance thereof. In the fuel cell, when the current value is small, the resistance is great, and as the current value increases, the resistance decreases. Then, if the current value exceeds a certain value, supply of gas in the fuel cell becomes insufficient, and the insufficiency of gas increases the resistance. Depending on the magnitude of current flowing through the fuel cell, there is a possibility that voltage variation becomes great when ripple is applied, so that the upper limit voltage or the lower limit voltage of the prescribed voltage range of the battery might be exceeded. FIG. 7 shows the relationship between the current value of DC current inputted/outputted to/from the fuel cell and the voltage value thereof. In the fuel cell, when the current value is small, the voltage becomes great.

In a case where the detection unit 1 detects the current value of DC current inputted/outputted to/from the power storage device 10, the impedance calculation unit 2 stores in advance information indicating the relationship between the current value of DC current inputted/outputted to/from the power storage device 10 and the resistance thereof as shown in FIG. 5 or FIG. 6, and calculates the resistance value corresponding to the impedance of the power storage device 10, from the current value detected by the detection unit 1 and the information indicating the relationship between the current value and the resistance as shown in FIG. 5 or FIG. 6. The information as shown in FIG. 5 or FIG. 6 may be stored as a map, a table, an expression, or a function.

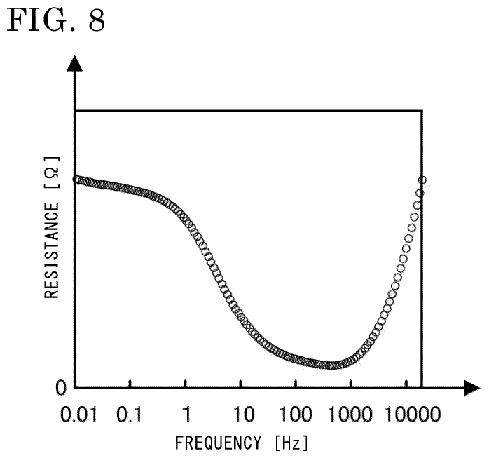

FIG. 8 is an impedance Bode plot showing the relationship between a frequency and the resistance of a lithium-ion battery. In FIG. 8, resistance values over a frequency range of 10 mHz to 20 kHz are shown. The resistance value in a frequency range of 1 kHz to 20 kHz is greatly influenced by the impedance of wiring inside the battery, or if a plurality of batteries are connected in series or parallel as a battery module, the impedance of wiring between the batteries, and further, the impedance of wiring from the battery to the converter. The resistance value when the frequency is 1 kHz corresponds to the electrolytic solution resistance in the lithium-ion battery and the DC resistance of the internal wiring, etc. The resistance value in a frequency range not higher than 1 kHz corresponds to the impedance in reaction between Li ions and the positive and negative electrodes inside the lithium-ion battery or diffusion of Li ions in the electrodes and in the electrolytic solution. In the impedance-frequency characteristics, as shown in FIG. 8, the higher the ripple frequency is, the greater the resistance value is, and in the vicinity of about 1 kHz, the resistance value is minimized, and in a low-frequency range not higher than 1 kHz, the resistance value increases. Thus, depending on the frequency of ripple current applied to the lithium-ion battery, voltage variation in the battery when the ripple current is applied is changed.

In a case where the detection unit 1 detects the frequency of ripple current applied to the power storage device 10, the impedance calculation unit 2 stores in advance information indicating the relationship between the frequency of ripple current applied to the power storage device 10 and the resistance thereof as shown in FIG. 8, and calculates the resistance value corresponding to the impedance of the power storage device 10, from the frequency of ripple current detected by the detection unit 1 and the information indicating the relationship between the frequency of ripple current and the resistance as shown in FIG. 8. The information as shown in FIG. 8 may be stored as a map, a table, an expression, or a function. In detection for the frequency of ripple current by the detection unit 1, for example, analysis using fast Fourier transform (FFT) may be performed and the frequency that appears at the highest occurrence ratio may be employed as a detection result.

In a case where the power storage device 10 is formed by connecting a plurality of batteries, the impedance calculation unit 2 may calculate the battery impedance of the entire power storage device 10 including the plurality of connected batteries, the impedances of a cable and a bus bar for connecting the plurality of batteries, and the impedance of a cable connecting the power storage device 10 and the converter 20. Basically, the power storage device 10 is not formed from one battery, but is used as a module in which a plurality of batteries are connected in series or parallel, so that the influence of the battery impedance and the impedances of the bus bar and the cable used for connection is great. Therefore, since the impedance calculation unit 2 calculates the battery impedance of the entire power storage device 10 including the plurality of connected batteries, the impedances of the cable and the bus bar for connecting the plurality of batteries, and the impedance of the cable connecting the power storage device 10 and the converter 20, ripple current applied to the power storage device 10 can be accurately calculated. In addition, since the impedances of the bus bar and the cable have characteristics of changing depending on the temperature and the frequency, the characteristics may be stored as information to calculate the impedances.

In addition, the impedance of the power storage device 10 calculated by the impedance calculation unit 2 has a tendency of changing as deterioration of the battery progresses. Therefore, the detection unit 1 may further detect the deterioration state or the deterioration degree of the battery, and the relationship between the deterioration degree and the resistance may be stored, to calculate the impedance of the battery in the deterioration state.

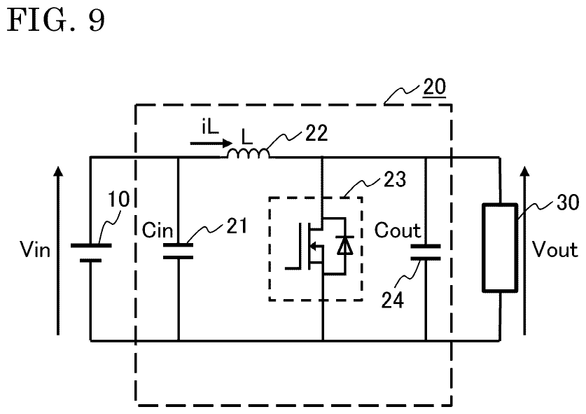

Next, a method for calculating ripple current by the ripple current calculation unit 3 will be described. FIG. 9 shows an example of an equivalent circuit of the converter 20. In FIG. 9, the converter 20 is a boost converter and is composed of a primary-side capacitor 21, a reactor 22, a semiconductor switching element 23, and a secondary-side capacitor 24. The converter 20 boosts input voltage Vᵢₙ from the power storage device 10 to output voltage Vₒᵤₜ, and outputs the output voltage Vₒᵤₜ to the load 30.

The inductance value of the reactor 22 is denoted by L, current flowing through the reactor 22 is denoted by iL, and the input voltage of the reactor 22 is denoted by Vᵢₙ. In this case, during an ON period Tₒₙ of the semiconductor switching element 23, the current iL increases by diL, and there is a relationship as shown by the following Expression (1).

$$[ Mathematical 1 ]$$

$${V}_{in} = L \frac{diL}{{T}_{on}} \qquad ( 1 )$$

By arranging Expression (1), the following Expression (2) is obtained.

$$[ Mathematical 2 ]$$

$$diL = \frac{{V}_{in} {T}_{on}}{L} \qquad ( 2 )$$

The ON period Tₒₙ of the semiconductor switching element 23 is represented by the following Expression (3) using a switching frequency f and an ON duty cycle D of the semiconductor switching element 23 and the input voltage Vᵢₙ and the output voltage Vₒᵤₜ of the converter 20.

$$[ Mathematical 3 ]$$

$${T}_{on} = \frac{D}{f} = \frac{1}{f} \times \frac{{V}_{out} - {V}_{in}}{{V}_{out}} \qquad ( 3 )$$

The ripple current diL is represented by the following Expression (4) on the basis of Expression (2) and Expression (3).

$$[ Mathematical 4 ]$$

$$diL = \frac{{V}_{in} ( {V}_{out} - {V}_{in} )}{L \times f \times {V}_{out}} \qquad ( 4 )$$

A peak value P_{d}iL of ripple current is represented by the following Expression (5).

$$[ Mathematical 5 ]$$

$${P}_{diL} = \frac{{V}_{in} ( {V}_{out} - {V}_{in} )}{2 \times L \times f \times {V}_{out}} \qquad ( 5 )$$

The ripple current diL shown by Expression (4) is applied as ripple current to the power storage device 10 by a capacitance Cᵢₙ of the primary-side capacitor 21, so that voltage variation occurs by the impedance of the power storage device 10. As described above, the ripple current calculation unit 3 calculates ripple current on the basis of the switching frequency f of the semiconductor switching element 23 such as MOSFET, a step-up/down voltage ratio between the primary-side voltage Vᵢₙ and the secondary-side voltage Vₒᵤₜ, the inductance value L of the reactor 22, the capacitance Cᵢₙ of the primary-side capacitor 21, and the capacitance Cₒᵤₜ of the secondary-side capacitor 24 in the converter 20. The ripple current calculation unit 3 may acquire and store in advance information about the inductance value L of the reactor 22, the capacitance Cᵢₙ of the primary-side capacitor 21, and the capacitance Cₒᵤₜ of the secondary-side capacitor 24 of the converter 20, or may acquire them from the converter 20 together with the values of the switching frequency f of the semiconductor switching element 23 such as MOSFET, the primary-side voltage Vᵢₙ, and the secondary-side voltage Vₒᵤₜ. The ripple current calculation unit 3 may acquire information about the switching frequency f of the semiconductor switching element 23 such as MOSFET, the primary-side voltage Vᵢₙ, and the secondary-side voltage Vₒᵤₜ, from the control unit 5. Alternatively, a timing for performing sampling may be set on the basis of the switching frequency of the semiconductor switching element 23 of the converter 20, to measure ripple current by the detection unit 1, and the value thereof may be used.

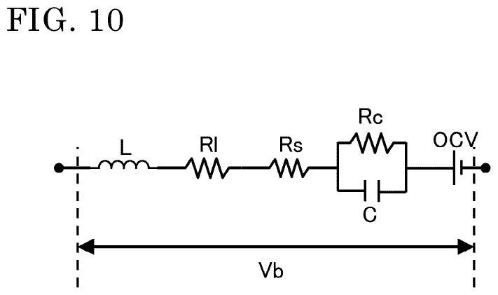

The ripple current calculation unit 3 may calculate ripple current on the basis of the equivalent circuit of the power storage device 10. FIG. 10 shows an equivalent circuit of the power storage device 10, and represents electrical and chemical properties of the power storage device 10 by a simple electric circuit. In FIG. 10, L denotes the inductance of a conduction path inside the power storage device 10, current collector metal, and the bus bar and the cable between the batteries of the battery module, Rl denotes a wiring resistance, Rs denotes an electrolytic solution resistance inside the battery, Rc denotes a reaction resistance due to reaction inside the battery, C denotes an electric double layer capacitance, and OCV (open circuit voltage) denotes open circuit voltage of the battery. After the constant of each element is set, for example, the equivalent circuit shown in FIG. 10 is applied to the input voltage Vi shown in FIG. 9, whereby ripple current upon AC application can be calculated through simulation. Alternatively, in Expressions (1) to (5), instead of the input voltage Vᵢₙ, the voltage Vb of the equivalent circuit of the power storage device 10 shown in FIG. 10 may be used to calculate ripple current. The equivalent circuit may be formed by only inductance and resistance components regarding the bus bar and the cable between the batteries, or may include the inductances and the resistances of the conduction path in the battery and metal of the electric collectors.

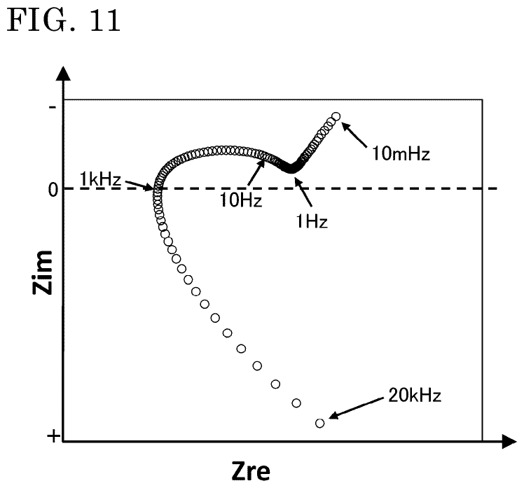

For example, the lithium-ion battery has a structure in which the electrodes and the current collectors are wound, and the inductance inside the battery and the inductance and resistance components based on the conduction path might be great. FIG. 11 is an impedance Nyquist diagram of one cell of the battery. In FIG. 11, regarding the impedance of one cell of the battery, the value thereof at each frequency is plotted as a real part Zre and an imaginary part Zim separately. In FIG. 11, the impedance based on the inductance of the battery has the imaginary part Zim in a positive range, and exhibits such characteristics that, in the positive range of Zim, the inductance and the real component increase as the frequency becomes higher. By applying the equivalent circuit with the above characteristics reflected therein, it becomes possible to more accurately calculate ripple current applied to the battery, whereby voltage variation of the battery can be estimated. In addition, it is possible to calculate ripple current by applying the impedance calculated on the basis of the characteristics shown in FIG. 11, as a resistance, to the input voltage Vᵢₙ shown in FIG. 9. The constant of each circuit element of the equivalent circuit may be variably set in accordance with the type and the electric or chemical property of the battery, thereby calculating the impedance according to the battery to be used. Further, as the equivalent circuit, an equivalent circuit based on the wiring inductance and the wiring resistance of the bus bar or the cable used for connection between the batteries may be used. Since the circuit element constants of the wiring and the cable change depending on the temperature and the frequency, the relationship of such changes may be prepared and used for calculation.

The ripple variation calculation unit 4 estimates voltage variation when ripple current is applied to the power storage device 10, from the value of the impedance which is output of the impedance calculation unit 2 and the value of ripple current which is output of the ripple current calculation unit 3. Since voltage variation of the power storage device 10 is estimated on the basis of the value of the impedance of the power storage device 10, it is possible to more accurately determine whether or not the power storage device 10 is used outside the upper limit voltage or the lower limit voltage of the prescribed voltage range thereof, whereby performance reduction or deterioration of the battery can be more accurately suppressed.

The control unit 5 controls the converter 20 on the basis of information of voltage variation of the power storage device 10 which is output of the ripple variation calculation unit 4, thereby controlling ripple current applied to the power storage device 10 and controlling the converter 20 so that voltage of the power storage device 10 does not go outside the prescribed voltage range of the power storage device 10 set in advance. Control of ripple current is performed by adjusting the switching frequency of the semiconductor switching element inside the converter 20, for example. In a case where switching operation of the semiconductor switching element is performed using a PWM signal based on pulse width modulation, control of ripple current may be performed by adjusting the carrier frequency for generating the PWM signal. The amplitude of ripple current may be controlled to be reduced by increasing the switching frequency of the semiconductor switching element or the carrier frequency for generating the PWM signal, or the amplitude of ripple current may be controlled to be increased by decreasing the switching frequency of the semiconductor switching element or the carrier frequency for generating the PWM signal. Alternatively, in the control unit 5, a voltage target value for the power storage device 10 may be set, and control may be performed so as to increase or decrease the voltage value or the SOC. Further, a current target value for current to flow through the power storage device 10 may be set, to control the current value.

The control unit 5 may include a deterioration determination unit. The deterioration determination unit determines the need for controlling ripple current, and a control target, on the basis of information of voltage variation of the power storage device 10 which is output of the ripple variation calculation unit 4, thereby controlling ripple current applied to the power storage device 10. For example, in the deterioration determination unit, if voltage variation calculated by the ripple variation calculation unit 4 on the basis of the voltage or the SOC of the power storage device 10 detected by the detection unit 1 exceeds any of the upper limit voltage, the upper limit SOC, the lower limit voltage, and the lower limit SOC of the power storage device 10, it is determined that control of ripple current is needed, and ripple current is controlled.

Further, when ripple current occurring due to switching operation of the converter 20 is applied to the power storage device 10 and voltage variation of the power storage device 10 exceeds the upper limit voltage or the lower limit voltage, the deterioration determination unit calculates a voltage excess value which is a difference between the upper limit voltage or the lower limit voltage and the voltage of the power storage device 10. The deterioration determination unit may store in advance information indicating the relationship between the voltage excess value and the deterioration speed of the power storage device 10, e.g., the relationship between the voltage excess value and change in the capacity of the power storage device 10, and may control ripple current applied to the power storage device 10 so that the deterioration speed becomes slow, on the basis of the calculated voltage excess value and the information indicating the relationship between the voltage excess value and the deterioration speed of the power storage device 10. The deterioration determination unit may store in advance information indicating the relationship between the number of times of application of ripple current and change in the capacity of the power storage device 10, and may control ripple current applied to the power storage device 10 so that the deterioration speed becomes slow, on the basis of the calculated voltage excess value and the information indicating the relationship between the number of times of application of ripple current and the deterioration speed of the power storage device 10. The information indicating the relationship between the voltage excess value and the deterioration speed of the power storage device 10 or the information indicating the relationship between the number of times of application of ripple current and change in the capacity of the power storage device 10 may be stored as a map, a table, an expression, or a function.

The deterioration speed of the power storage device 10 with respect to voltage variation of the power storage device 10 changes depending on the temperature of the power storage device 10 detected by the detection unit 1. Therefore, the deterioration determination unit may store in advance information indicating the relationship among the temperature of the power storage device 10, voltage variation calculated by the ripple variation calculation unit 4, and the deterioration speed of the power storage device 10, and may control ripple current on the basis of this information. The information indicating the relationship among the temperature of the power storage device 10, voltage variation calculated by the ripple variation calculation unit 4, and the deterioration speed of the power storage device 10 may be stored as a map, a table, an expression, or a function.

The upper limit voltage or the lower limit voltage of the power storage device 10 changes depending on the temperature of the power storage device 10 detected by the detection unit 1. Therefore, the deterioration determination unit may change the upper limit voltage or the lower limit voltage in accordance with the temperature of the power storage device 10 detected by the detection unit 1, and may control ripple current so that the power storage device 10 is less deteriorated, on the basis of a difference between the upper limit voltage or the lower limit voltage and voltage variation of the power storage device 10 when ripple current is applied. With this configuration, for example, in a case of the lithium-ion battery, battery deterioration at a low temperature can be suppressed because the lithium-ion battery has such characteristics that, at a low temperature, deterioration of the lithium-ion battery due to deposition of Li on the negative electrode more progresses when ripple current occurring due to switching operation of the converter 20 is applied to the power storage device 10. In addition, also at a high temperature, in the lithium-ion battery, reduction decomposition reaction of the electrolytic solution, side reaction of the negative and positive electrodes, and deposition of Li metal, more progress when ripple current occurring due to switching operation of the converter is applied to the battery. Therefore, deterioration at a high temperature can be suppressed.

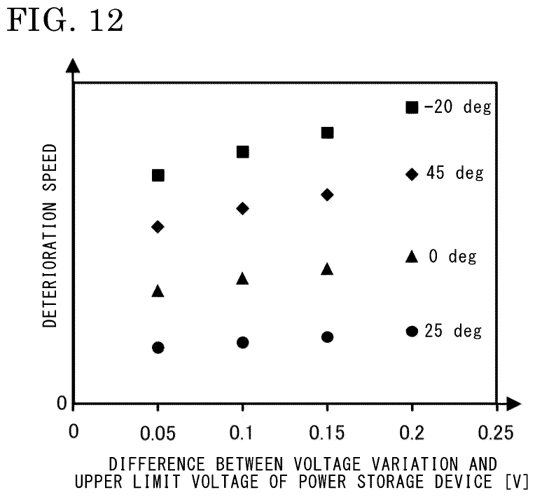

FIG. 12 shows the relationship between the deterioration speed and a difference between voltage variation of the power storage device 10 and the upper limit voltage thereof, at each temperature of the power storage device 10. Squares indicate values at −20 degrees Celsius, triangles indicate values at 0 degrees Celsius, circles indicate values at 25 degrees Celsius, and rhombuses indicate values at 45 degrees Celsius. The deterioration determination unit may store the information as shown in FIG. 12 in advance, and may control ripple current so that the power storage device 10 is less deteriorated, on the basis of a difference between the upper limit voltage and voltage variation of the power storage device 10 when ripple current is applied. The information as shown in FIG. 12 may be stored as a map, a table, an expression, or a function.

There is a case where, when ripple current is applied to the power storage device 10, the temperature thereof increases so as to exceed an upper limit temperature of the power storage device set in advance, so that the power storage device 10 is deteriorated. The deterioration determination unit may calculate a heat generation amount of the power storage device 10 from the value of the impedance calculated by the impedance calculation unit 2 and ripple current calculated by the ripple current calculation unit 3, calculate the temperature of the power storage device 10 increased by the heat generation amount, and control ripple current on the basis of information of the increased temperature. A heat generation amount Q based on ripple current occurring due to switching operation of the converter 20 and an internal resistance R of the power storage device 10 is defined by the following Expression (6), using Iᵣₘₛ which denotes effective current of ripple.

[Mathematical 6]

Q=RIᵣₘₛ² (6)

Here, the internal resistance R of the power storage device 10 changes depending on the temperature of the power storage device 10, the SOC thereof, current inputted thereto, current outputted therefrom, or the frequency of ripple current applied thereto, detected by the detection unit 1. Therefore, as the internal resistance R, the resistance value of the impedance calculated by the impedance calculation unit 2 may be used. Temperature increase in the power storage device 10 can be estimated on the basis of a heat capacity Cv [J/K] of the battery and energy generated with time and the heat generation amount Q of the power storage device 10 calculated from the Expression (6). Through the above process, it is possible to prevent such a phenomenon that, when ripple current occurring due to switching operation of the converter 20 is applied to the power storage device 10, the temperature of the power storage device 10 increases due to heat generation inside the power storage device 10 and deterioration of the power storage device 10 progresses.

The deterioration determination unit may store in advance information indicating the relationship among temperature increase due to heat generation inside the power storage device 10, voltage variation of the power storage device 10, and the deterioration speed of the power storage device 10 when ripple current is applied, and control ripple current on the basis of this information. Due to current ripple applied to the power storage device 10 and the impedance of the power storage device 10, Joule heat generation occurs in the power storage device 10, so that the temperature of the power storage device 10 increases. Therefore, in particular, in a case of being used at a high temperature, the temperature of the power storage device 10 becomes even higher due to temperature increase, so that performance reduction or deterioration might occur. However, by the deterioration determination unit performing the process as described above, performance reduction or deterioration of the power storage device 10 can be suppressed. The information indicating the relationship among temperature increase due to inside heat generation, voltage variation of the power storage device 10, and the deterioration speed of the power storage device 10 may be stored as a map, a table, an expression, or a function.

The deterioration determination unit may store in advance information indicating the relationship between a time integral value of voltage of the power storage device 10 and the deterioration speed of the power storage device 10, calculate a time integral value of voltage with respect to battery voltage variation due to ripple current application and the frequency of ripple current, and control ripple current on the basis of the time integral value of the voltage. Alternatively, the deterioration determination unit may store in advance the relationship between an effective voltage value of voltage of the power storage device 10 and the deterioration speed of the power storage device 10, calculate an effective voltage value of voltage of the power storage device 10, and control ripple current on the basis of the effective voltage value. The deterioration progress speed of the battery changes depending on the time integral value or the effective voltage of voltage in voltage variation of the power storage device 10 when ripple current is applied. Therefore, by controlling ripple current on the basis of the time integral value or the effective voltage value of the voltage, performance reduction or deterioration of the power storage device 10 can be suppressed. The information indicating the relationship between the time integral value of voltage of the power storage device 10 and the deterioration speed of the power storage device 10 may be stored as a map, a table, an expression, or a function.

The deterioration determination unit may control ripple current applied to the battery, on the basis of the frequency of ripple current occurring due to switching operation of the converter 20. The lithium-ion battery has such characteristics that, through movement of Li ions in the electrolytic solution inside the battery or electrode reaction in the battery, deterioration more progresses when, for example, ripple current in a frequency range not higher than 1 kHz is applied. Therefore, in a case where ripple current having a frequency not higher than 1 kHz is applied, the deterioration determination unit may perform control such as suppressing ripple current applied to the power storage device 10, whereby performance reduction or deterioration of the power storage device 10 can be controlled.

In the case of the lithium-ion battery, the value of the upper limit voltage of the power storage device 10 to be used in the deterioration determination unit needs to be changed in accordance with a factor for deterioration. Therefore, the deterioration determination unit may be provided with a deterioration factor diagnosis unit for diagnosing a deterioration factor for the power storage device 10, and in the deterioration determination unit, ripple current may be controlled on the basis of information of the deterioration factor diagnosed by the deterioration factor diagnosis unit. In the deterioration factor diagnosis unit, for example, as a general method, a voltage curve and a derivative voltage curve of a battery not deteriorated, and a voltage curve and a derivative voltage curve of a deteriorated battery, are respectively analyzed and compared with each other, and positive electrode deterioration, negative electrode deterioration, and deterioration due to deposition of Li are diagnosed as parameters. Then, if the deterioration parameter due to deposition of Li exceeds a threshold, control is performed so as to suppress ripple current. It is not always necessary to analyze and compare both a voltage curve and a derivative voltage curve, and only either one of them may be analyzed and compared. For example, in the lithium-ion battery, while Li is deposited on the negative electrode, Li ions which move in the positive and negative electrodes through charging/discharging are consumed, so that capacity reduction or deterioration occurs. In this case, as deposition of Li progresses, a separator is penetrated through to cause slight short-circuit or internal short-circuit. Therefore, the above control can suppress performance reduction and deterioration of the battery.

The inductance value of the reactor and the capacitance of the capacitor provided in the converter 20 may be designed as follows. At a design stage in advance, ripple current occurring due to switching operation of the converter 20 is calculated, and then an assumed impedance of the power storage device 10 is calculated and voltage variation is estimated. On the basis of this, the inductance value and the capacitance may be designed. With such processes, it is possible to reduce the size of the reactor or reduce the capacitance of the capacitor provided to the converter 20.

As described above, the control device 100 according to embodiment 1 is the control device 100 for controlling the converter 20 which converts at least one of voltage inputted to the power storage device 10 and voltage outputted from the power storage device 10, by a semiconductor switching element, the control device 100 including: the detection unit 1 for detecting a power storage device parameter relevant to the power storage device 10; the impedance calculation unit 2 which calculates the impedance of the power storage device 10 from output of the detection unit 1; and the ripple current calculation unit 3 which calculates the amplitude of ripple current applied to the power storage device 10, from output of the detection unit 1. The converter 20 is controlled on the basis of output of the impedance calculation unit 2 and output of the ripple current calculation unit 3. Thus, performance reduction or deterioration of the power storage device 10 can be suppressed.

### Embodiment 2

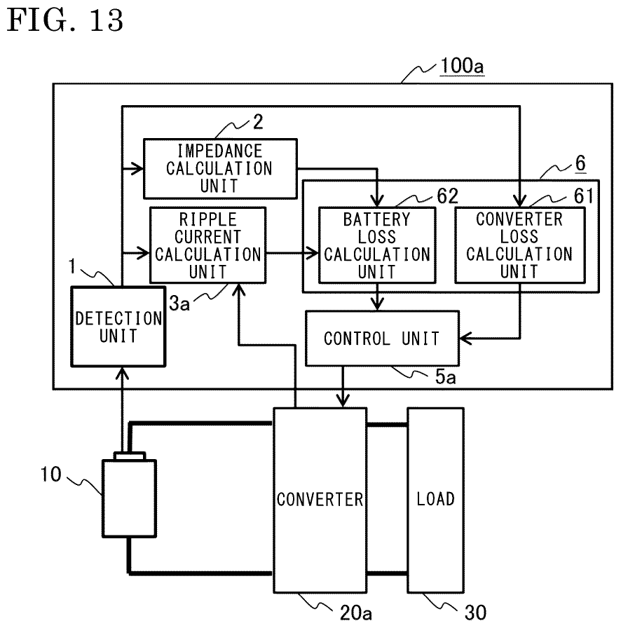

FIG. 13 shows the configuration of a control device 100a according to embodiment 2. The control device 100a according to embodiment 2 controls a converter 20a including a plurality of reactors connected in parallel to each other and a plurality of semiconductor switching elements connected to the plurality of reactors. In the control device 100a according to embodiment 2 shown in FIG. 13, as compared to the control device 100 according to embodiment 1 shown in FIG. 1, the ripple current calculation unit 3 is replaced with a ripple current calculation unit 3a, the control unit 5 is replaced with a control unit 5a, and a loss calculation unit 6 is provided instead of the ripple variation calculation unit 4. The loss calculation unit 6 includes a converter loss calculation unit 61 and a battery loss calculation unit 62. The other configurations of the control device 100a according to embodiment 2 are the same as those of the control device 100 according to embodiment 1.

A configuration including the control device 100a, the power storage device 10, and the converter 20a corresponds to a power storage system.

The ripple current calculation unit 3a calculates the magnitude of ripple current applied to the power storage device 10, on the basis of output of the detection unit 1 and the number of the reactors operating in the converter 20a, i.e., the number of the semiconductor switching elements operating in the converter 20a. The converter loss calculation unit 61 acquires the value of DC current inputted/outputted to/from the power storage device 10, from the detection unit 1, and calculates converter loss which is loss occurring due to switching operations of the semiconductor switching elements of the converter 20a, on the basis of the value of the DC current. The battery loss calculation unit 62 calculates the amount of inside heat generation due to the impedance of the power storage device 10, which is battery loss occurring in the power storage device 10, on the basis of the value of the impedance of the power storage device 10 which is output of the impedance calculation unit 2 and the value of ripple current which is output of the ripple current calculation unit 3. The control unit 5a controls the number of the semiconductor switching elements to be operated in the converter 20a, on the basis of the value of converter loss which is output of the converter loss calculation unit 61 and the value of battery loss which is output of the battery loss calculation unit 62. With the above configuration, the number of reactors to be operated is increased in consideration of converter loss and battery loss, whereby ripple current is suppressed and thus performance reduction of the power storage device 10 can be suppressed.

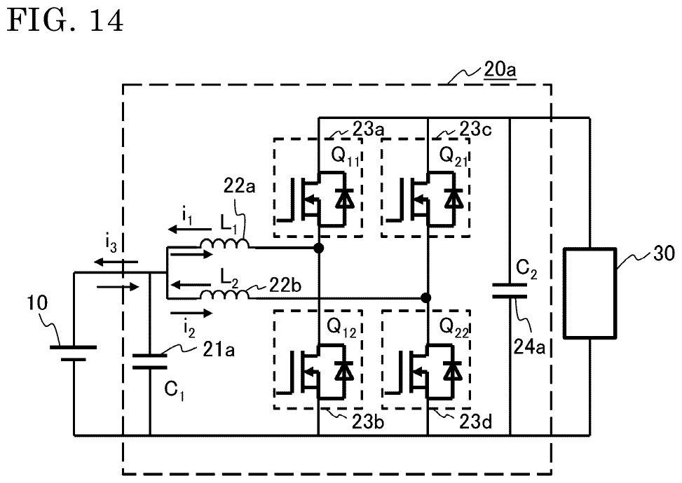

A method for controlling ripple current will be described, using an example in which the converter 20a is duplexed by having two reactors for converting voltage. FIG. 14 shows an equivalent circuit of the converter 20a. In FIG. 14, the converter 20a is composed of a primary-side capacitor 21a, a reactor 22a, a semiconductor switching element 23a, a semiconductor switching element 23b, a reactor 22b, a semiconductor switching element 23c, a semiconductor switching element 23d, and a secondary-side capacitor 24a.

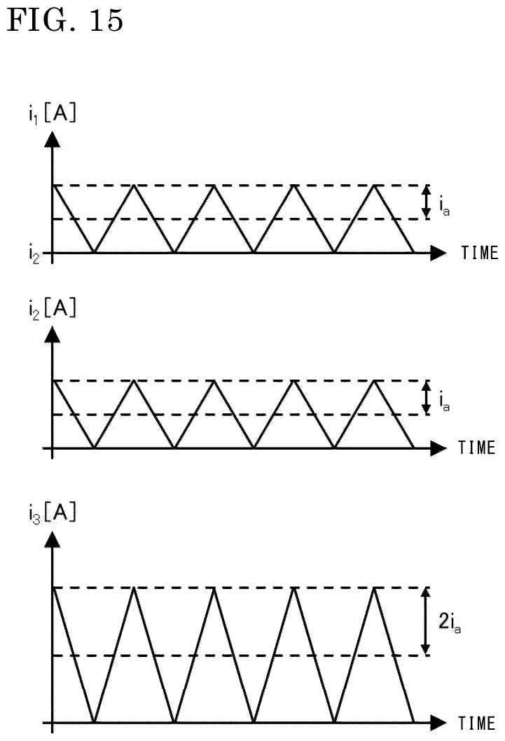

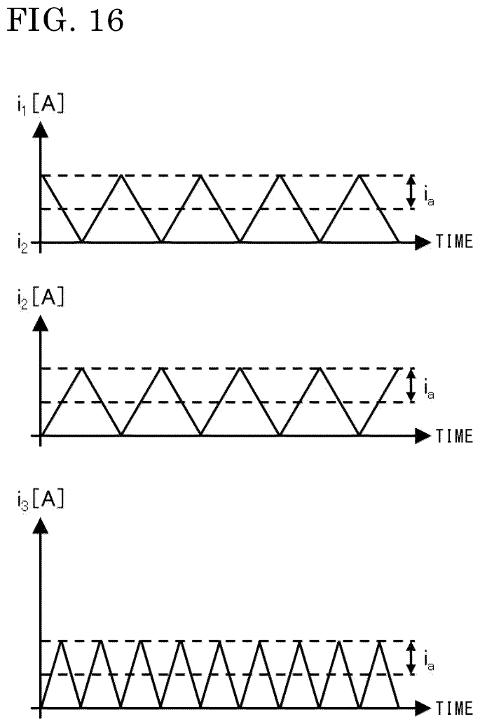

In the converter 20a having duplexed reactors, ripple current flowing through the reactor 22a when the semiconductor switching element 23a and the semiconductor switching element 23b are caused to perform switching operations at the carrier frequency f is denoted by i₁, and ripple current flowing through the reactor 22b when the semiconductor switching element 23c and the semiconductor switching element 23d are caused to perform switching operations at the carrier frequency f is denoted by i₂. Ripple current i₃ obtained by combining i₁ and i₂ is applied to the power storage device 10. FIG. 15 shows i₁, i₂, and i₃ in a case of performing switching operations of the semiconductor switching elements so that i₁ and i₂ have the same phase in a converter in a comparative example. Current ripples i₁ and i₂ having an amplitude of iₐ and the same phase are combined, so that the ripple current i₃ has an amplitude of 2iₐ. On the other hand, FIG. 16 shows i₁, i₂, and i₃ in a case of performing switching operations of the semiconductor switching elements so that the phases of i₁ and i₂ are shifted from each other by 180 degrees in the converter of embodiment 2. Current ripples i₁ and i₂ having an amplitude of iₐ and phases shifted from each other by 180 degrees are combined, so that the ripple current i₃ has an amplitude of iₐ and a frequency of 2f. In the converter of embodiment 2, the ripple current i₃ having the amplitude of iₐ after combination is applied to the power storage device 10, and thus the amplitude of ripple current applied to the power storage device 10 can be reduced as compared to the comparative example in which switching operations of the semiconductor switching elements are performed so that i₁ and i₂ have the same phase. In addition, by having duplexed reactors, DC current flowing through each reactor is reduced as compared to a case where DC current having the same magnitude flows through only one reactor, whereby the heat generation amount in the converter 20a is reduced.

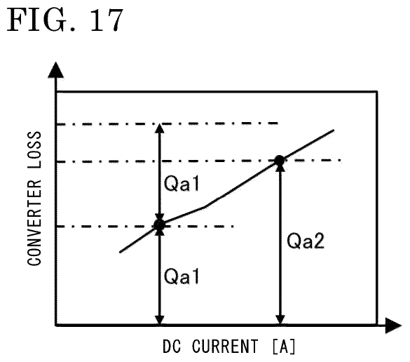

On the other hand, in the case of having duplexed reactors, loss due to switching occurs, thus having disadvantage that efficiency is reduced. FIG. 17 shows the relationship between DC current and loss in a case of boosting voltage in the converter 20a. In FIG. 17, converter loss per reactor in a case of performing operation with duplexed reactors is denoted by Qa1, and converter loss in a case of performing operation with only one reactor without duplexed reactors is denoted by Qa2. In the case of performing operation with duplexed reactors, current flowing per reactor becomes small and converter loss per reactor also becomes small, but converter loss in the entire converter 20a becomes 2Qa1. In order to reduce converter loss in the entire converter 20a, for example, the control unit 5a compares 2Qa1 which is converter loss in the case of performing operation with duplexed reactors and Qa2 which is converter loss in the case of performing operation with only one reactor, and performs control so as to perform operation with only one reactor when 2Qa1 is greater than Qa2. Regarding the relationship between DC current and converter loss, the loss may be calculated on the basis of efficiency with respect to current when voltage of the power storage device 10 is boosted or stepped down by the converter 20a.

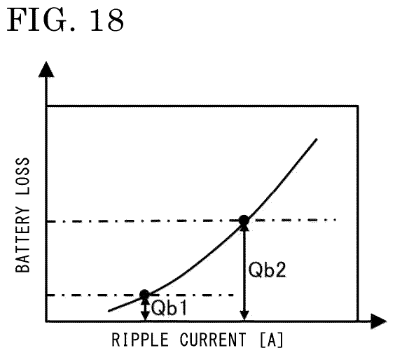

FIG. 18 shows the relationship between ripple current applied to the power storage device 10 and battery loss in the power storage device 10 calculated on the basis of the impedance, i.e., loss due to heat generation in the power storage device 10. In FIG. 18, battery loss in the power storage device 10 in the case of performing operation with duplexed reactors is denoted by Qb1, and battery loss in the power storage device 10 in the case of performing operation with only one reactor without duplexed reactors is denoted by Qb2. In order to reduce battery loss in the power storage device 10, for example, the control unit 5a compares Qb1 which is battery loss in the case of performing operation with duplexed reactors and Qb2 which is battery loss in the case of performing operation with only one reactor, and performs control so as to perform operation with smaller battery loss. In addition, in order to reduce the sum of converter loss in the converter 20a and battery loss in the power storage device 10, for example, the control unit 5a compares 2Qa1+Qb1 and Qa2+Qb2, and determines the number of reactors to be operated in the converter 20a, to perform control.

The control device 100a may further include the ripple variation calculation unit 4 which estimates voltage variation of the power storage device 10 on the basis of the values of the impedance and the ripple current, and the control unit 5a may control the number of the semiconductor switching elements to be operated, so as to reduce ripple current applied to the power storage device 10. This configuration can prevent such a phenomenon that, when voltage variation of the power storage device 10 occurs due to the impedance of the power storage device 10 and ripple current applied to the power storage device 10, the upper limit voltage or the lower limit voltage is exceeded and thus the power storage device 10 is deteriorated.

Regarding the number of reactors connected in parallel in the converter 20a, more than two reactors may be multiplexed, and the control unit 5a may determine the number of reactors to be operated, thereby controlling ripple current applied to the power storage device 10. By increasing the number of reactors, ripple current applied to the power storage device 10 can be more reduced. In the case of controlling the converter 20a having a large number of reactors connected in parallel, since loss in the entire converter 20a is a value obtained by summing loss due to switching operation per reactor over the number of all the reactors, it is possible to reduce converter loss in the converter 20a by decreasing the number of reactors to be operated in consideration of ripple current.

Since a rated current value is prescribed for the reactors, in a case of stopping some of the multiplexed reactors, it is desirable to control the number of reactors to be operated so that current flowing through each operating reactor is not greater than the rated current value. As shown in FIG. 17, when two or more reactors are operated, converter loss in the entire converter 20a tends to increase. Therefore, in a case where the load is small and the converter 20a is operated with small DC current not greater than the rated current value of the reactors, it is possible to reduce converter loss in the converter 20a by operating only one reactor. For example, in the converter 20a shown in FIG. 14, if ripple current i₃ applied to the power storage device 10 is not greater than ½ of the rated current of the reactors, the gates of the semiconductor switching element 23c and the semiconductor switching element 23d are turned off to stop the reactor 22b, whereby converter loss in the converter 20a can be reduced. At this time, the ripple current i₁ flowing through the reactor 22a becomes the ripple current i₃ applied to the power storage device 10.

The control device according to each of embodiments 1 and 2 may be implemented as a control method or may be implemented as a computer program describing operations in the control method. The computer program may be provided via a communication path or may be provided by being stored in a storage medium.

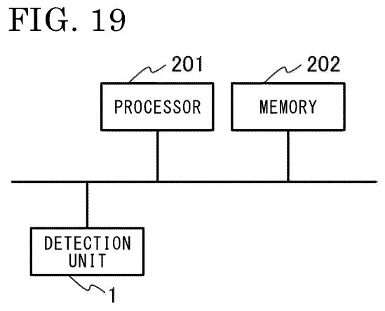

FIG. 19 is a schematic diagram showing an example of hardware of the control device according to each of embodiments 1 and 2. The impedance calculation unit 2, the ripple current calculation unit 3, 3a, the ripple variation calculation unit 4, the control unit 5, 5a, and the loss calculation unit 6 are implemented by a processor 201 such as a central processing unit (CPU) for executing a program stored in a memory 202. The memory 202 is used also as a temporary storage device in each process executed by the processor 201. The above functions may be executed through cooperation of a plurality of processing circuits. The above functions may be implemented by dedicated hardware.

In a case of implementing the above functions by dedicated hardware, the dedicated hardware is, for example, a single circuit, a complex circuit, a programmed processor, a parallel-programmed processor, an application specific integrated circuit (ASIC), a field programmable gate array (FPGA), or a combination thereof. In a case of implementing the above functions by the processor 201 and the memory 202, the processor 201 is a CPU, i.e., a central processing unit, a processing device, a computation device, a microprocessor, a microcomputer, a digital signal processor (DSP), or the like, or a combination thereof. The memory 202 is, for example, a nonvolatile or volatile semiconductor memory such as a random access memory (RAM), a read only memory (ROM), a flash memory, an erasable programmable ROM (EPROM), or an electrically EPROM (EEPROM (registered trademark)), a magnetic disk, a flexible disk, an optical disc, a compact disc, a mini disc, a digital versatile disk (DVD (registered trademark)), or a combination thereof. The detection unit 1, the processor 201, and the memory 202 are connected to each other via a bus.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 detection unit
2 impedance calculation unit
3, 3a ripple current calculation unit
4 ripple variation calculation unit
5, 5a control unit
6 loss calculation unit
10 power storage device
20, 20a converter
21, 21a primary-side capacitor
22, 22a, 22b reactor
23, 23a, 23b, 23c, 23d semiconductor switching element
24, 24a secondary-side capacitor
30 load
61 converter loss calculation unit
62 battery loss calculation unit
100, 100a control device
201 processor
202 memory

1. A control device for controlling a converter which converts at least one of voltage inputted to a power storage device and voltage outputted from the power storage device, by a semiconductor switching element, the control device comprising:
a detector to detect a power storage device parameter relevant to the power storage device;
an impedance calculator to calculate an impedance of the power storage device from output of the detector; and
a ripple current calculator to calculate an amplitude of ripple current applied to the power storage device, from output of the detector, wherein
the converter is controlled on the basis of output of the impedance calculator and output of the ripple current calculator.

2. The control device according to claim 1, further comprising:
a ripple variation calculator to estimate voltage variation of the power storage device from output of the impedance calculator and output of the ripple current calculator; and
a controller to control the converter so that the voltage variation does not go outside a prescribed voltage range of the power storage device set in advance.

3. The control device according to claim 2, wherein
the controller controls the ripple current applied to the power storage device, by controlling switching operation of the semiconductor switching element.

4. The control device according to claim 2, wherein
the controller controls a voltage value of DC voltage applied to the power storage device, by controlling switching operation of the semiconductor switching element.

5. The control device according to claim 2, wherein
the power storage device parameter relevant to the power storage device is at least one of a temperature of the power storage device, a voltage value of DC voltage inputted to the power storage device, a voltage value of DC voltage outputted from the power storage device, an SOC of the power storage device, a current value of DC current inputted to the power storage device, a current value of DC current outputted from the power storage device, and a frequency of the ripple current applied to the power storage device.

6. The control device according to claim 2, wherein
the impedance calculator converts output of the detector to a value of the impedance of the power storage device on the basis of information indicating a relationship between output of the detector and the impedance of the power storage device.

7. The control device according to claim 2, wherein
the power storage device includes wiring therein, and
the impedance calculator calculates the impedance of the power storage device including also an impedance of the wiring.

8. The control device according to claim 2, wherein
the controller includes a deterioration determination circuitry to control switching operation of the semiconductor switching element on the basis of information of a deterioration speed of the power storage device.

9. The control device according to claim 8, wherein
the deterioration determination circuitry controls switching operation of the semiconductor switching element on the basis of the information of the deterioration speed of the power storage device due to the voltage variation.

10. The control device according to claim 8, wherein
the deterioration determination circuitry calculates the deterioration speed of the power storage device from a heat generation amount of the power storage device estimated from output of the impedance calculator and output of the ripple current calculator.

11. The control device according to claim 8, wherein
the deterioration determination circuitry calculates the deterioration speed of the power storage device from a time integral value of the voltage variation.

12. The control device according to claim 8, wherein
the deterioration determination circuitry calculates the deterioration speed of the power storage device from effective voltage calculated from the voltage variation.

13. The control device according to claim 8, wherein
the detector detects at least a frequency of the ripple current applied to the power storage device, and
the controller controls switching operation of the semiconductor switching element on the basis of the information of the deterioration speed of the power storage device due to the frequency of the ripple current applied to the power storage device.

14. The control device according to claim 1, for controlling the converter including a plurality of reactors connected in parallel to each other and a plurality of the semiconductor switching elements connected to the plurality of reactors, wherein
a number of the semiconductor switching elements to be operated is controlled on the basis of output of the impedance calculator, output of the ripple current calculator, and output of the detector.

15. The control device according to claim 14, further comprising:
a converter loss calculator to calculate loss in the converter from output of the detector;
a battery loss calculator to calculate loss in the power storage device from output of the impedance calculator and output of the ripple current calculator; and
a controller to determine the number of the semiconductor switching elements to be operated, from output of the converter loss calculator and output of the battery loss calculator.

16. A power storage system comprising:
the control device according to claim 1;
the power storage device; and
the converter.
